(19) United States
(12) Patent Application Publication
(10) Pub. No.: US 2005/0174245 A1
(43) Pub. Date: Aug. 11, 2005

(54) System for monitoring water within a bathtub

(76) Inventors: Thomas J. Delaney, Manhattan Beach, CA (US); Jennifer L. Delaney, Manhattan Beach, CA (US)

Correspondence Address: Squire, Sanders & Dempsey L.L.P.;14th Floor, 801 S. Figueroa Street, Los Angeles, CA, 90017-5554, US

(21) Appl. No.: 10/777,513

(22) Filed: Feb. 11, 2004

(51) Int. Cl. G08B 17/00

(52) U.S. Cl. 340/584; 340/573.1; 4/496

(57) ABSTRACT

This invention is directed to a system capable of indicating to a user that a desired water temperature and/or the water level within a bathtub have been reached. The system includes a water sensor so that as the running water fills the bathtub, the system may activate an alarm if the water sensor detects the water at a predetermined level within the bathtub. This may assist in preventing the water within the bathtub from overflowing. The system may also include a temperature sensor to monitor the temperature of the water in the bathtub so that if the temperature of the water reaches a predetermined temperature, the system may sound an alarm as well. The system includes a transmitter that sends a signal to a receiver to notify to the user that the alarm has been activated. The receiver may be remote from the transmitter to allow the user to carry the receiver. The receiver may be also communicably coupled to a lighting device, such as a lamp, to turn on or off the light to indicate to the user that the alarm has been activated.

### BACKGROUND OF THE INVENTION

1. Field of the Invention

This invention relates to a system that monitors the temperature and water level within a bathtub and notifying a user when a predetermined water level and/or predetermined temperature of the water are reached.

2. General Background and State of the Art

Many devices have been devised to indicate to the user the water temperature and water level within a bathtub. When the water temperature reaches a certain temperature, a device may sound an alarm so that water does not get too hot to burn a toddler, for example. A device may sound an alarm if the water level within the bathtub reaches a critical level where the water may overflow. When the alarm is sound, however, it is competing with the noise of the running water such that the alarm may not be heard by the user. Alternatively, the user may be away from the bathtub such that the sound of the alarm may not be heard. In such instances, the bathwater may still overflow from the bathtub or temperature of the water may rise above the desire water temperature. Accordingly, there still is a need for notifying a user of the water temperature and the water level within a bathtub.

### INVENTION SUMMARY

This invention is directed to a system that monitors the water within a bathtub such as temperature and/or the water level within the bathtub. When the water temperature and/or the water level reaches a certain level, the system sounds an alarm to indicate to the user that the water temperature or the water level have reached a predetermined level within the bathtub. The system includes a housing with a water sensor that is adjustable along the vertical axis so that a user may adjust the depth to which the water sensor may be placed into the bathtub. The housing may also have a temperature sensor to detect the temperature of the water within the bathtub. As the water temperature and/or water level within the bathtub reaches a predetermined level, the system may sound an alarm. When the alarm is activated, the system may send a signal through a transmitter that is received by a receiver that is remote from the transmitter. The receiver may be carried by a user or near a user so that the user may be notified of the alarm even if the user is away from the bathtub. In addition, the background noise of the running water into the bathtub does not hinder the user from being notified of the alarm. The receiver may be communicably coupled to a vibrator and carried by the user so that even if the user is hearing-impaired, the vibration of the receiver may notify the user of the alarm. Additionally, the receiver may be communicably coupled to a light source to flash the light on and off to indicate to the user that the alarm has been sound. The system may also include a display device that indicates the water temperature of the bathtub. The system may also have support for holding bath supplies such as soap, shampoo and the like, on the outside of the bathtub.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 is a perspective view of a system capable of monitoring water in a bathtub.

FIG. 2 is an enlarge view of the system.

FIG. 3 is a cross-sectional view of a housing.

FIG. 4 illustrates a receiver incorporated into a light system.

### DETAILED DESCRIPTION OF THE PREFERRED EMBODIMENTS

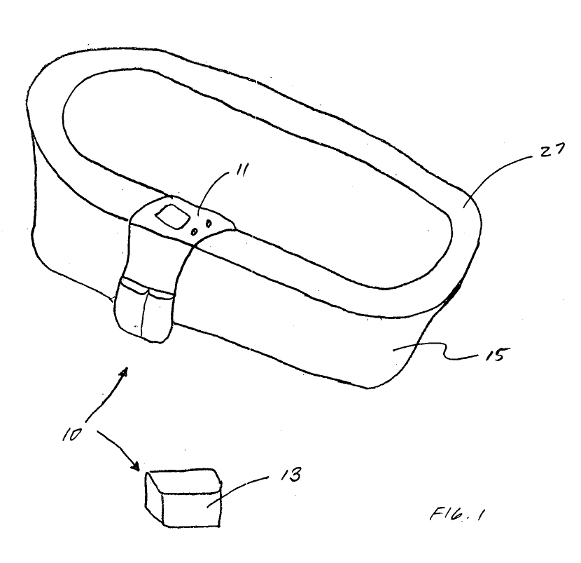

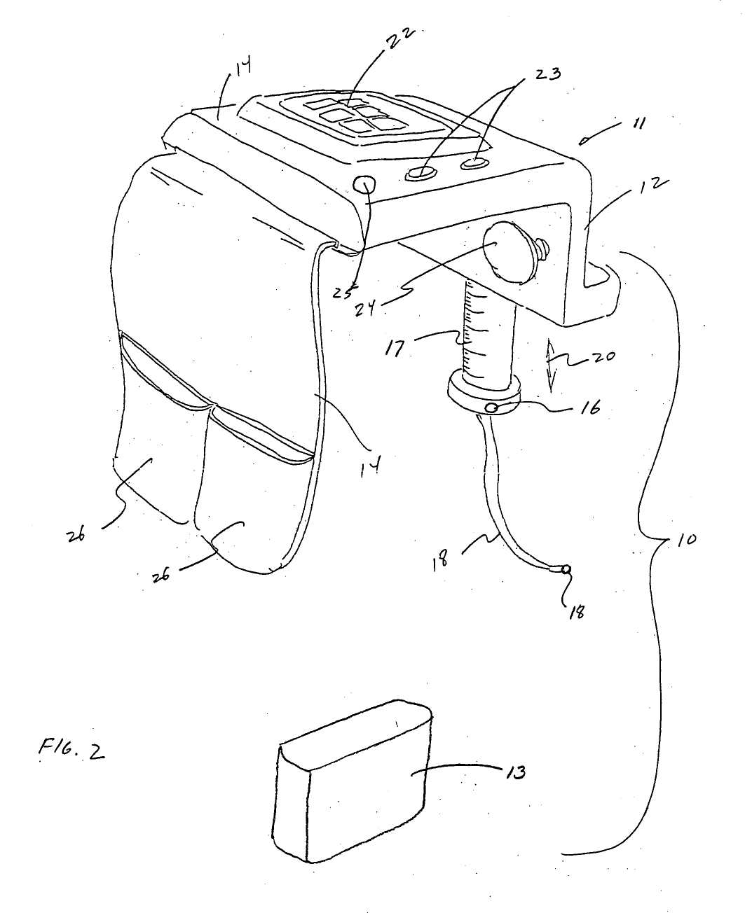

FIG. 1 illustrates a perspective view of a system 10 including a housing 11 and a receiver 13 adapted to receive a signal provided from the housing 11. The housing may have an inverted U-shape configuration adapted associate or placed over a rim 27 of a bathtub 15. FIG. 2 illustrates that the housing 11 includes an inner-leg 12 and an outer-leg 14, with a base 14 between the two legs. The housing 11 may rest on the rim 27 of the bathtub so that the inner-leg 12 may be placed inside of the bathtub and the outer-leg 14 may be placed outside of the bathtub, with the base 14 sitting on top of the rim 17 of the bathtub. The system 10 may include a water sensor 16 and a water temperature sensor 18. The water sensor 16 may be adjustably coupled to the housing 11 so that a user may adjust the location of the water sensor 16 along the vertical axis. As indicated by the direction arrow 20, the water level sensor 16 may be adjusted along the vertical axis so that a user may adjust the depth of the water sensor 16 into the bathtub to detect the water once the water reaches a predetermined depth. The housing 11 may be adjustably coupled to a tube 17, where one end of the tube 17 may be inserted and extended from the housing. The free end of the tube 17 may be coupled to the water sensor 16 so that position of the water sensor may be adjusted along the vertical axis.

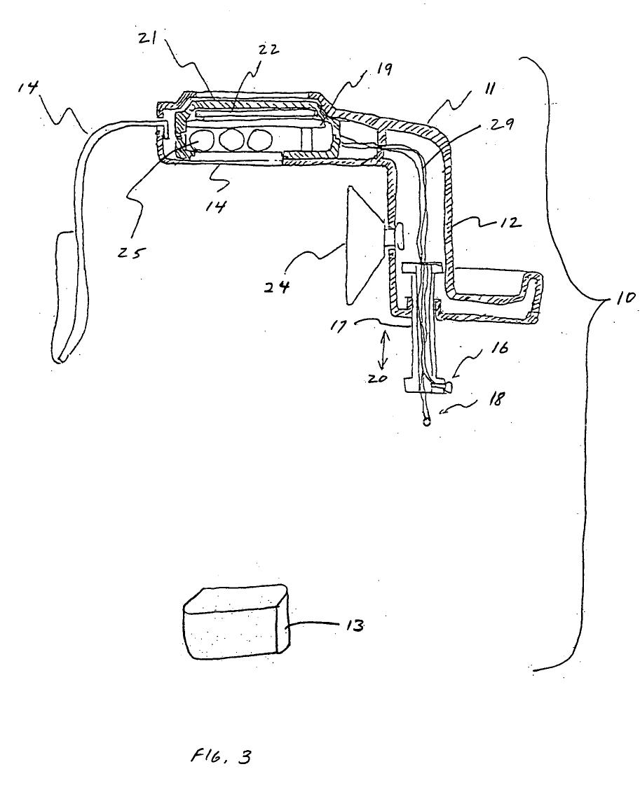

FIG. 3 illustrates a cross-sectional view of the housing 11. The temperature sensor 18 may be coupled to the housing to detect the temperature of the water within the bathtub. The temperature sensor 18 may be a thermal couple, for example. The temperature sensor 18 may extend from the tube 17. The temperature sensor 18 and the water sensor 16 may be coupled to their respective wires 29 to provide the sensing information to a circuit 19 within the housing. The circuit 19 may display the information corresponding to the temperature sensor 18 and the water sensor 16 to display 22 such as a LCD on the base 14 to display the temperature of the water in the bathtub or whether water level has reached the predetermined level or not. The circuit may be communicably coupled to a speaker 21 that sounds an alarm when the temperature of the water or the water level reaches a predetermined setting. The desired temperature of the water may be set through input buttons 23 (FIG. 2) with the display 22 indicating the set or predetermined temperature.

The system 10 may also include a transmitter 25 embedded into the base 14 of the housing 11 adapted to communicate with the receiver. When the alarm is activated, the circuit 19 may send an alarm signal through the transmitter 25 which is received by the receiver 13. The alarm signal may be sent wirelessly. The receiver 13 may be a variety of devices adapted to notify its user that the alarm signal has been received. The receiver 13, for example, may be a pager, mobile phone, or home phone. The pager, for example, may beep or vibrate to alert its user that the alarm signal has been sent. In the vibration mode, the pager may notify the user even with the background noise of the running water into the bathtub, if the user is away from the bathtub or is hearing-impaired.

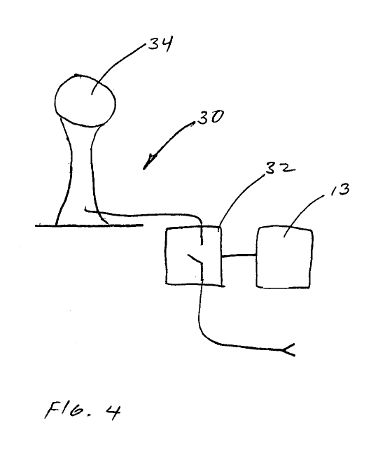

As illustrated in FIG. 4, the receiver 13 may be incorporated into a light system 30 within a home. The receiver 13 may be communicably coupled to the control switch 32 providing power to the light system 30. As the receiver receives the signal from the transmitter 25, the receiver may cause the control switch 32 to turn on and off the power to the light 34 to notify the user of the signal being activated. As such, the receiver may be incorporated into a variety of mobile devices to notify a user through sound, vibration, light, or any other means to indicate that the alarm has been sound. In addition, the system 10 may be used to monitor any type of liquid in a container and to notify the user of liquid temperature and its level within the container.

The housing 11 may have a suction-cup 24 within the inner-leg 12 to couple the housing 11 to the bathtub 15. The outer-leg 14 may have pockets 26 to hold shampoo, conditioner, and soap and the like. The inner leg 12 may also be also formed to have a dish configured to hold soap and the like.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

1. A system for monitoring liquid in a container, the system comprising:
a housing adapted to associate with a rim of the container;
a temperature sensor coupled to the housing adapted to measure the temperature of the liquid in the container;
a transmitter;
a circuit communicably coupled to the temperature sensor such that if the temperature of the liquid reaches a predetermined temperature, the circuit activates an alarm signal through the transmitter; and
a receiver adapted to receive the alarm signal and notify the user of the alarm signal, where the receiver is remote from the housing.

2. The system according to claim 1, where the liquid is water and the container is a bathtub.

3. The system according to claim 1, further including a water level sensor adjustably coupled to the housing for detecting water, where the water level sensor is communicably coupled to the circuit to transmit the alarm signal to the receiver if the water level sensor detects water.

4. The system according to claim 1, where the housing has an inner leg and an outer leg and a base between the inner and outer legs, where the base is adapted to sit on top of the rim of the container, and the inner leg is adapted to coupled to the temperature sensor.

5. The system according to claim 1, where the housing includes a display to indicate the temperature of the liquid in the container.

6. The system according to claim 4, where the outer leg has a pocket adapted to hold a bottle.

7. The system according to claim 1, where the receiver is a pager that notifies a user that the alarm signal has been received.

8. The system according to claim 7, where the pager vibrates if the alarm signal has been received.

9. The system according to claim 1, where the receiver is a phone that rings if the alarm signal has been received.

10. The system according to claim 1, where the receiver is electrically coupled to a light device to turn on and off the light device if the alarm signal has been received.

11. A system for monitoring liquid in a container, the system comprising:
a housing adapted to associate with a rim of the container;
a liquid sensor adjustably coupled to the housing to adjust the depth of the liquid sensor within the container at a predetermined level to detect the liquid in the container;
a transmitter;
a circuit communicably coupled to the liquid sensor such that if the liquid sensor detects liquid within the container at the predetermined level, the circuit send an alarm signal through the transmitter; and
a receiver adapted to receive the signal and notify that the alarm signal has been received, where the receiver is remote from the housing.

12. The system according to claim 11, where the liquid is water and the container is a bathtub.

13. The system according to claim 11, further including a temperature sensor to measure the temperature of the liquid in the container, where the circuit is communicably coupled to the temperature sensor such that if the temperature of the liquid reaches a predetermined temperature, the circuit sends an alarm signal through the transmitter.

14. The system according to claim 13, where the housing has a display to indicate the temperature of the liquid in the container.

15. The system according to claim 11, where the housing has an inner leg and an outer leg and a base between the inner and outer legs, where the base is adapted to sit on top of the rim of the container, and the inner leg is adapted to coupled to the liquid sensor.

16. The system according to claim 15, where the outer leg has a pocket adapted to hold a bottle.

17. The system according to claim 11, where the receiver is a pager that notifies a user that the alarm signal has been received.

18. The system according to claim 17, where the pager vibrates if alarm signal has been received.

19. The system according to claim 11, where the receiver is a phone that rings if the alarm signal has been received.

20. The system according to claim 11, where the receiver is electrically coupled to a light to turn on and off the light if the alarm signal has been received.

21. A system for monitoring water in a bathtub, the system comprising:
a housing adapted to associate with a rim of the bathtub;
a water sensor adjustably coupled to the housing to adjust the depth of the water sensor within the bathtub at a predetermined level to detect the water in the bathtub;
a temperature sensor coupled to the housing adapted to measure the temperature of the water in the bathtub;
a transmitter;
a circuit communicably coupled to the water sensor and the temperature sensor such that if the water sensor detects water within the bathtub at the predetermined level or the temperature of the water reaches a predetermined temperature, the circuit sends an alarm signal through the transmitter; and
a receiver adapted to receive the alarm signal and notify that the alarm signal has been received, where the receiver is remote from the housing.

22. The system according to claim 21, where the housing has a display to indicate the temperature of the water in the bathtub.

23. The system according to claim 21, where the housing has an inner leg and an outer leg and a base between the inner and outer legs, where the base is adapted to sit on top of the rim of the bathtub, and the inner leg is adapted to coupled to the water sensor and the temperature sensor.

24. The system according to claim 23, where the outer leg nas a pocket adapted to hold a bottle.

25. The system according to claim 21, where the receiver is a pager that notifies a user that the alarm has been activated.

26. The system according to claim 25, where the pager vibrates if the alarm is activated.

27. The system according to claim 21, where the receiver is a phone that rings if the alarm signal has been received.

28. The system according to claim 21, where the receiver is electrically coupled to a light to turn on and off the light if the alarm signal has been received.

29. A housing for monitoring water within a bathtub, the housing comprising:
an inner leg adapted to couple to a water sensor and a temperature sensor;
an outer leg having a pocket adapted to hold a bottle; and
a base between the inner and outer legs, the base adapted to associate with a rim of the bathtub and having a display to indicate the temperature of the water, where the base includes a circuit to sound an alarm if the water sensor detects water within a predetermined depth of the bathtub or the temperature of the water within the bathtub reaches a predetermined temperature.

30. The housing according to claim 29, where the inner leg is adapted to hold a soap.

31. The housing according to claim 29, where the inner leg is adjustably coupled to a tube to position the tube along a vertical axis, where the tube is coupled to the water sensor.

32. A method for monitoring water in a bathtub, the method comprising:
detecting water within the bathtub at a predetermined depth;
monitoring the temperature of the water within the bathtub;
transmitting a signal if the detecting detects water at the predetermined depth or if the temperature of the water reaches a predetermined temperature; and
receiving the signal remotely to notify of the transmitting of the signal.

33. The method according to claim 32, further including:
displaying the temperature of water within the bathtub.

34. The method according to claim 32, further including:
holding bottles.

35. The method according to claim 32, further including:
flashing a light on and off when the receiving of the signal.

36. The method according to claim 32, further including:
vibrating a pager when the receiving of the signal.

37. The method according to claim 32, further including:
ringing a phone when the receiving of the signal.
